(19) United States
(12) Patent Application Publication
(10) Pub. No.: US 2022/0286605 A1
(43) Pub. Date: Sep. 8, 2022

(54) IMAGING DEVICE, IMAGE PROCESSING DEVICE, AND METHOD OF CONTROLLING IMAGING DEVICE

(71) Applicant: CANON KABUSHIKI KAISHA, Tokyo (JP)

(72) Inventor: Yurie Uno, Kanagawa (JP)

(21) Appl. No.: 17/673,833

(22) Filed: Feb. 17, 2022

(30) Foreign Application Priority Data
Mar. 4, 2021 (JP) 2021-034260

(51) Int. Cl. H04N 5/232

(52) U.S. Cl. CPC H04N 5/23229; H04N 5/232933; H04N 5/23206

(57) ABSTRACT

An imaging device includes at least one memory and at least one processor which function as: an acquisition unit configured to acquire imaging setting information in capturing of a reference image and image editing information applied to the reference image; an imaging unit configured to control of imaging using the imaging setting information acquired by the acquisition unit; and an editing unit configured to edit a captured image captured by the imaging unit based on the image editing information acquired by the acquisition unit.

### BACKGROUND OF THE INVENTION

### Field of the Invention

The present invention relates to an imaging device, an image processing device, and a method of controlling the imaging device.

### Description of the Related Art

In recent years, the number of services for posting images on a social networking service (hereinafter referred to as an SNS) has increased. The posted images are posted after processing such as tint adjustment and lightness adjustment after imaging in some cases. When the posted images are processed, users may want to process the images which have atmospheres similar to those of images of other users posting on the SNS in some cases. Therefore, there are users who have publicize, as photo-recipes, camera setting values in imaging and retouching information which is image editing information used to process captured images.

When images are generated with reference to a photo-recipe, users perform imaging with setting similar to the camera setting values of the photo-recipes and the captured images are edited similarly to with the retouching information. In this way, capturing of images based on photo-recipes and processing of the captured images are time-consuming work.

Japanese Patent Application Publication No. 2014-68228 discloses a technology for acquiring editing information of sample images captured by other users and reflecting the editing information of the sample images in users' own captured images.

When the camera setting values in imaging are different despite application of the editing information of the sample image to users' own captured images, the processed images intended by the users are not obtained in some cases. In some cases, it may be difficult for users who have insufficient knowledge of cameras to set the cameras by themselves even though the users have looked at photo-recipes.

### SUMMARY OF THE INVENTION

The present invention provides an image processing system reducing time and effort for generating an image with an atmosphere similar to that of an image selected by a user.

An imaging device according to the aspect of the invention includes at least one memory and at least one processor which function as: an acquisition unit configured to acquire imaging setting information in capturing of a reference image and image editing information applied to the reference image; an imaging unit configured to control of imaging using the imaging setting information acquired by the acquisition unit; and an editing unit configured to edit a captured image captured by the imaging unit based on the image editing information acquired by the acquisition unit.

Further features of the present invention will become apparent from the following description of exemplary embodiments with reference to the attached drawings.

### BRIEF DESCRIPTION OF THE DRAWINGS

FIG. 1 is a diagram illustrating an overview of an image processing system according to a first embodiment;

FIGS. 2A and 2B are block diagrams illustrating exemplary configurations of an editing device and an imaging device;

FIG. 3 is a diagram illustrating an item setting screen of camera setting values;

FIGS. 4A and 4B are diagrams illustrating camera tables;

FIG. 5 is a diagram illustrating an item setting screen of retouching information;

FIGS. 6A to 6C are diagrams illustrating app tables;

FIG. 7 is a diagram illustrating a photo-recipe registration screen;

FIG. 8 is a diagram illustrating a camera setting value table;

FIGS. 9A and 9B are diagrams illustrating a retouching information table;

FIG. 10 is a diagram illustrating an image camera-related table;

FIG. 11 is a diagram illustrating an image retouching information-related table;

FIG. 12 is a flowchart illustrating acquisition processing for the camera setting values;

FIGS. 13A and 13B are diagrams illustrating screens on which an image group is displayed on an imaging device;

FIG. 14 is a flowchart illustrating application processing for the retouching information;

FIG. 15 is a diagram illustrating a screen on which captured images before and after application of the retouching information are displayed;

FIG. 16 is a diagram illustrating an overview of an image processing system according to a second embodiment; and

FIG. 17 is a diagram illustrating an example in which captured images before and after application of the retouching information are switched.

### DESCRIPTION OF THE EMBODIMENTS

### First Embodiment

Hereinafter, a preferred exemplary embodiment of the present invention will be described in detail with reference to the drawings. Here, constituent elements described in the embodiment are merely exemplary and do not limit the scope of the present invention.

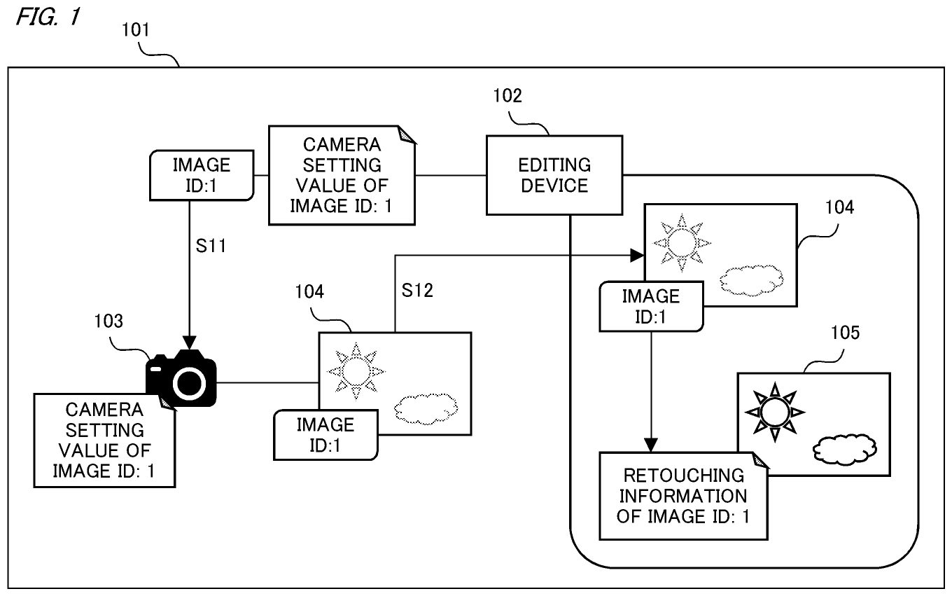

Image Processing System: An overview of an image processing system according to an embodiment will be described with reference to FIG. 1. An image processing system 101 includes an editing device 102 and an imaging device 103. The editing device 102 is equivalent to an image processing device.

The editing device 102 receives registration of a photo-recipe of captured images along with the captured images. The photo-recipe includes imaging setting information including camera setting values in capturing of the captured image and retouching information indicating content of editing processing for the captured image. The photo-recipe may be registered in association with captured images before application of retouching information and captured images after application of the retouching information. The retouching information can be managed by an application (hereinafter referred to as an app) capable of editing images. Items of the retouching information can be set for each app. The captured images after the application of the retouching information registered in the editing device 102 can be browsed from the imaging device 103 via the Internet or the like.

The imaging device 103 receives and displays an image group registered in the editing device 102. A user selects an image desired to be imitated in the image group as a reference image. The example of FIG. 1 is an example in which an image with an image ID: 1 is selected. The editing device 102 transmits the image ID: 1 of the selected reference image and camera setting values in imaging to the imaging device 103 when it is detected that the reference image is selected with the imaging device 103 (S11). The image ID is equivalent to identification information of the reference image and the camera setting value is equivalent to the imaging setting information.

The imaging device 103 sets the camera setting value of the image ID: 1 received (acquired) from the editing device 102 in a camera (an imaging unit). The imaging device 103 assigns the image ID: 1 to data of the captured image 104. The imaging device 103 transmits the captured image 104 to which the image ID: 1 is assigned, to the editing device 102 (S12).

The editing device 102 acquires the image ID: 1 assigned to the data of the captured image 104. The editing device 102 acquires retouch information of the image ID: 1. The editing device 102 generates an edited image 105 by applying the retouch processing to the captured image 104 in accordance with the retouch information of the image ID: 1. The retouch information is equivalent to image processing information. The edited image 105 is captured with the same camera setting values as those of an image desired to be imitated by the user and retouching processing is applied to in accordance with the same retouching information. Therefore, the user can obtain an image with an atmosphere similar to that of the image desired to be imitated. The user can obtain an image with an atmosphere similar to that of the selected image through a normal imaging operation without performing additional work by selecting an image desired to be imitated.

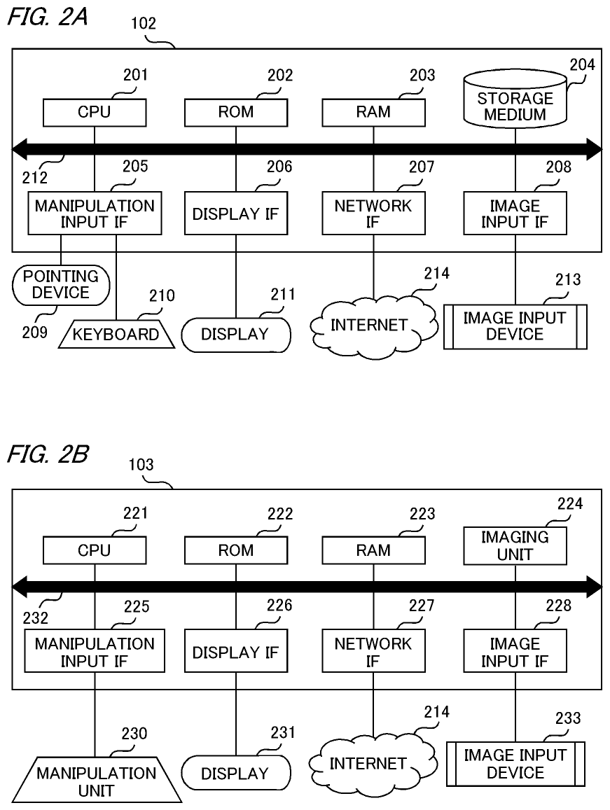

Device Configuration: A device configuration of the image processing system 101 according to the embodiment will be described with reference to FIGS. 2A and 2B. FIGS. 2A and 2B are block diagrams illustrating exemplary configurations of the editing device 102 and the imaging device 103.

In the examples of FIGS. 2A and 2B, the editing device 102 and the imaging device 103 are assumed to be single computers in the description, but the present invention is not limited thereto. The image processing system 101 may be implemented by a single computer, and the editing device 102 and the imaging device 103 may be implemented by distributing functions to a plurality of computers. Further, in the following description, some of the functions implemented by the editing device 102 may be performed by the imaging device 103 or some of the functions performed by the imaging device 103 may be performed by the editing device 102. When the image processing system 101 is configured by a plurality of computers, the computers are connected communicatively via a local area network (LAN) or the like.

FIG. 2A illustrates an exemplary configuration of the editing device 102. The editing device 102 is, for example, an electronic device such as a smartphone or a tablet terminal. A central processing unit (CPU) 201 is a control unit that controls the whole editing device 102. The CPU 201 operates each unit of the editing device 102 by reading and executing a program supplied from a read-only memory (ROM) 202, a recording medium 204 or the Internet 214 and controlling each device. The CPU 201 operates as, for example, a registration unit, an acquisition unit, an editing unit, a transmission unit, a reception unit, and a transfer unit.

A ROM 202 is a nonvolatile memory that stores programs and parameters which are not changed. A random access memory (RAM) 203 is a volatile memory that temporarily stores programs and data supplied from the recording medium 204, the Internet 214, or the like.

The recording medium 204 is a recording medium that includes a hard disk and a memory card installed and fixed to the editing device 102 or an optical disc, a magnetic card, and an IC card detachably mounted on the editing device 102. The recording medium 204 is equivalent to a storage unit.

A manipulation input IF 205 is an interface with an input device such as a pointing device 209 and a keyboard 210 that receive a user manipulation and input various kinds of data. A display IF 206 is an interface with a display device such as a display 211 that displays data maintained by the editing device 102 or data supplied from an external device.

A network IF 207 is an interface for connecting a network line such as the Internet 214. An image input IF 208 is an interface with an image input device 213. A system bus 212 connects each device communicatively.

FIG. 2B illustrates an exemplary configuration of the imaging device 103. A CPU 221 is a control unit that controls the whole imaging device 103. The CPU 221 operates each unit of the imaging device 103 by reading a program supplied from a ROM 222 and controlling each device. The CPU 221 operates as, for example, a registration unit, an acquisition unit, an editing unit, a display control unit, and a transfer unit.

Since a ROM 222, a RAM 223, a manipulation input IF 225, a display IF 226, a network IF 227, an image input IF 228, a display 231, and an image input device 233 are similar to corresponding configurations of the editing device 102, description thereof will be omitted.

An imaging unit 224 includes an optical system configured by a lens group including a zoom lens and a focus lens, an image sensor such as a CCD or CMOS sensor, an A/D conversion unit, and an image processing unit. The image sensor photoelectrically converts an optical image formed on an imaging surface by the optical system and outputs an obtained analog image signal to the A/D conversion unit. The A/D conversion unit converts the input analog image signal into digital image data. The image processing unit applies, for example, image processing such as defect correction process, demosaicing processing, white balance correction processing, color interpolation processing, and gamma processing of pixels originating from an optical system or an image sensor to the image data.

A manipulation unit 230 includes a manipulation member and a touch panel such as various keys, buttons, or dials. The manipulation unit 230 receives a manipulation such as an imaging manipulation or a manipulation of selecting the reference image from the user.

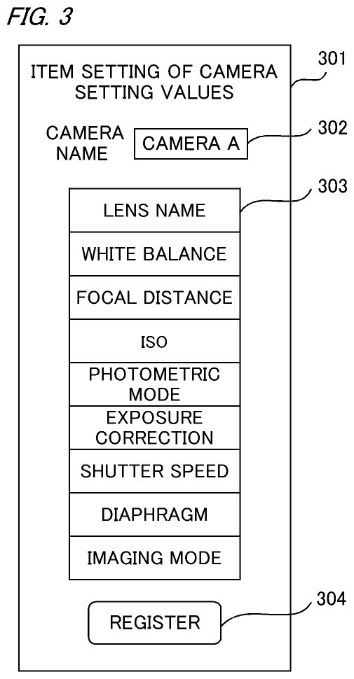

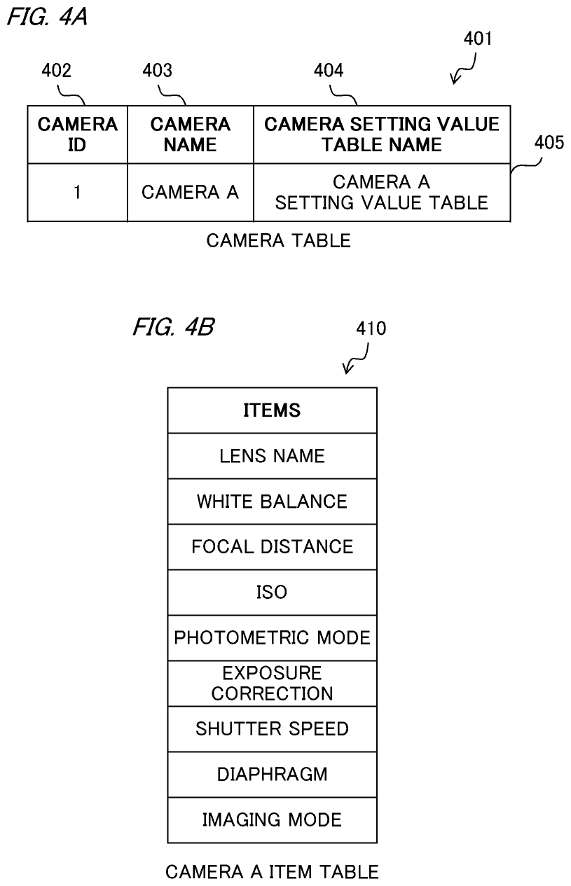

Item Setting of Camera Setting Values: Item setting of the camera setting values will be described with reference to FIGS. 3, 4A, and 4B. Information regarding the camera setting values of set items (imaging setting information) is registered in the recording medium 204 along with image data as a photo-recipe.

FIG. 3 is a diagram illustrating an item setting screen of camera setting values. When an instruction for item setting of camera setting values is received from the user, the CPU 201 of the editing device 102 displays a camera setting value item setting screen 301 on the display 211. The CPU 201 receives an input of a camera name 302 and a camera setting value item 303 from the user.

The camera name 302 is not limited to a case of being directly input and may be selected from options registered in advance. When the camera name 302 is input or selected, the CPU 201 can display items associated in advance with the camera name 302 as camera setting value items 303. The displayed items may be added to, deleted, or changed by the user.

When it is detected that a registration button 304 of the camera setting value item setting screen 301 is pressed, the CPU 201 registers the input or selected camera name 302 and camera setting value items 303 in a camera table 401.

The camera table 401 will be described with reference to FIGS. 4A and 4B. FIG. 4A is a diagram illustrating the camera table 401. The camera table 401 is a table for storing a relation between items of the camera names and the camera setting values. The camera table 401 includes columns of a camera ID 402, a camera name 403, and a camera setting value table name 404.

The camera ID 402 is an ID set for each camera. The camera name 403 is a name such as a model name of a camera. The camera setting value table name 404 is a table name with which a camera setting value is stored for each camera.

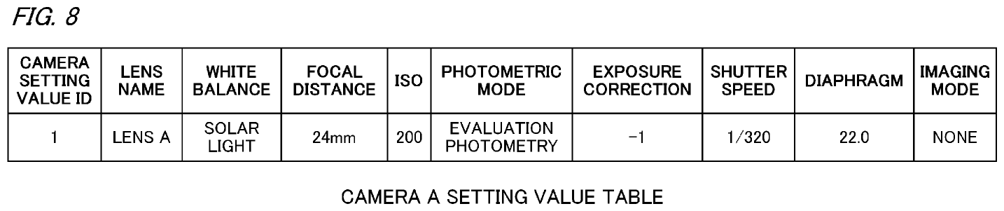

When the registration button 304 is pressed on the camera setting value item setting screen 301 illustrated in FIG. 3, a record 405 in FIG. 4A is inserted. In the camera ID 402 of the record 405, “1” is set as an ID for identifying a camera. In the camera name 403, “camera A” input in the camera name 302 is set. In the camera setting value table name 404, “camera A setting value table” for storing a setting value of each item of the camera setting value item 303 is set. The camera A setting value table will be described in detail in FIG. 8.

FIG. 4B is a diagram illustrating a camera A item table 410. The camera A item table 410 is a table in which each item of the camera setting value item 303 set on the camera setting value item setting screen 301 is registered. That is, the camera A item table 410 is a list of columns of the camera A setting value table.

Specifically, items of a lens name, white balance, a focal distance, ISO, a photometric mode, exposure correction, a shutter speed, a diaphragm, and an imaging mode are stored in the camera A item table 410. The camera A item table 410 in FIG. 4B shows an example in which items of the setting values for the camera A are stored, but the present invention is not limited thereto. Items of camera setting values for a plurality of cameras may be managed with one item table.

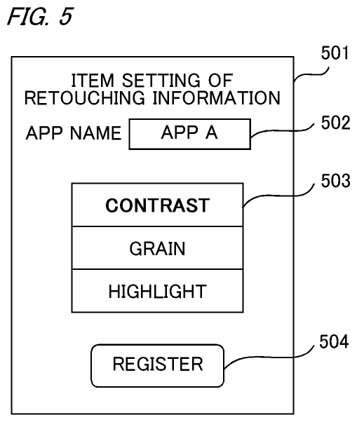

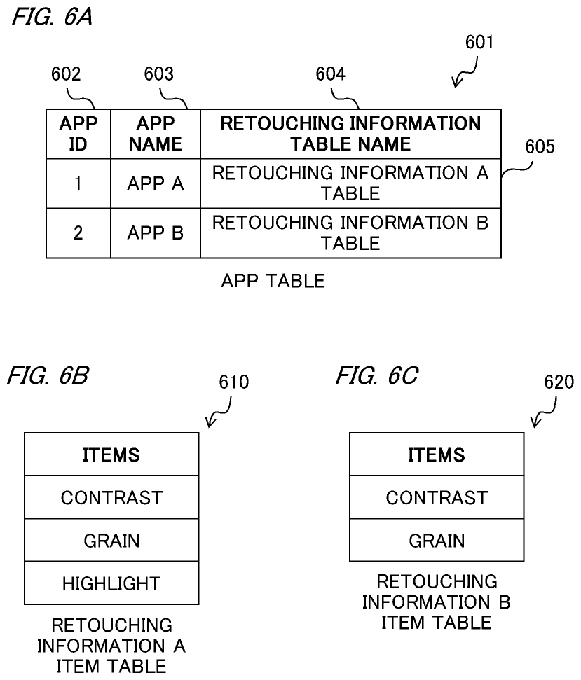

Item Setting of Retouching Information: Item setting of retouching information will be described with reference to FIGS. 5 and 6A to 6C. The touching information (image editing information) of the set items is registered as a part of the photo-recipe in the recording medium 204 along with image data.

FIG. 5 is a diagram illustrating an item setting screen of retouching information. When an instruction for item setting of the retouching information is received from the user, the CPU 201 of the editing device 102 displays a retouching information item setting screen 501 on the display 211. The CPU 201 receives an input of an app name 502 and a retouching information item 503 from the user.

The app name 502 is not limited to a case of being directly input and may be selected from options registered in advance. When the app name 502 is input or selected, the CPU 201 can display items associated in advance with the app name 502 as the retouching information item 503. The displayed items may be added to, deleted, or changed by the user.

When it is detected that a registration button 504 of the retouching information item setting screen 501 is pressed, the CPU 201 registers the input or selected app name 502 and retouching information items 503 in an app table 601.

The app table 601 will be described with reference to FIGS. 6A to 6C. FIG. 6A is a diagram illustrating the app table 601. The app table 601 is a table for storing a relation between items of the app names and the retouching information. The app table 601 includes columns of an app ID 602, an app name 603, and a retouching information table name 604.

The app ID 602 is an ID set for each app. The app name 603 is a name such as a name of an app capable of performing image editing. The retouching information table name 604 is a table name with which an item of a retouching information is stored for each app.

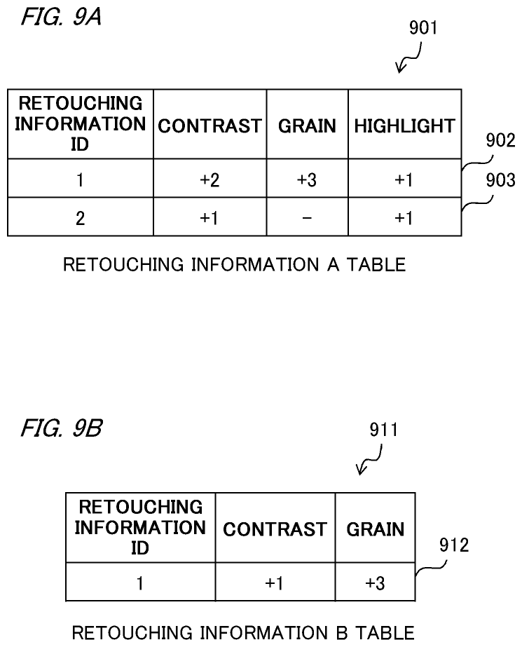

When the registration button 504 is pressed on the retouching information item setting screen 501 illustrated in FIG. 5, a record 605 in FIG. 6A is inserted. In the app ID 602 of the record 605, “1” is set as an ID for identifying an app. In the app name 603, “app A” input in the app name 502 is set. In the retouching information table name 604, “retouching information A table” for storing a setting value of each item of the retouching information item 503 is set. The retouching information A table will be described in detail in FIGS. 9A and 9B.

FIG. 6B is a diagram illustrating a retouching information A item table 610. The retouching information A item table 610 is a table in which each item of the retouching information item 503 set on the retouching information item setting screen 501 is registered. That is, the retouching information A item table 610 is a list of columns of the retouching information A table. Specifically, items of contrast, grain, and highlight are stored in the retouching information A item table 610.

Similarly, FIG. 6C is a diagram illustrating a retouching information B item table 620. Items of contrast and grain are stored in the retouching information B item table 620. FIGS. 6B and 6C illustrate examples in which the item table of the retouching information of the app is generated for each app, but the present invention is not limited thereto. The item tables of the retouching information for a plurality of apps may be managed with one item table.

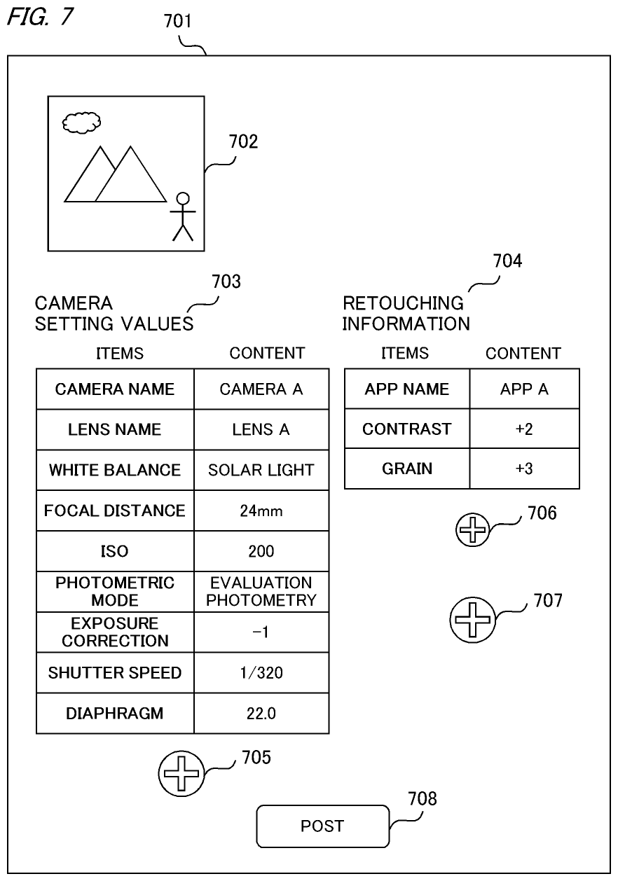

Registration of Photo-Recipe: Registration of a photo-recipe will be described with reference to FIG. 7. The photo-recipe is registered on the recording medium 204 or the like along with image data. The image data registered in the recording medium 204 is transmitted to the imaging device 103 and is displayed on the display 231. The user selects an image desired to be imitated as a reference image from the image group displayed on the display 231. The user can perform imaging with the same camera setting values as those as the reference image and generate an image to which the retouching processing is applied in accordance with the same retouching information as that of the reference image by selecting the reference image.

FIG. 7 is a diagram illustrating a photo-recipe registration screen 701. When an instruction to register the photo-recipe is received from the user, the CPU 201 of the editing device 102 displays the photo-recipe registration screen 701 on the display 211. The CPU 201 receives an input of an image 702, camera setting values 703, and retouching information 704 from the user.

Addition of items of camera setting values will be described. When it is detected that an item addition button 705 of camera setting values is pressed, the CPU 201 displays items of the camera setting values which can be added to “camera A” shown with a camera name of the camera setting values 703.

The CPU 201 acquires a record in which the camera name 403 is “camera A” from the camera table 401. The camera setting value table name 404 of the acquired record is “camera A setting value table.”

The CPU 201 refers to the camera A item table 410 of FIG. 4B in which the columns of the camera A setting value table are defined. The CPU 201 compares the items displayed in the camera setting value 703 with the items registered in the camera A item table 410, and adds the item “imaging mode” not included in the camera setting values 703 to the camera setting values 703 to display that item.

Similarly, when it is detected that an item addition button 706 of the retouching information is pressed, the CPU 201 displays items of retouching information which can be added to “app A” shown in the app name of the retouching information 704.

The CPU 201 acquires the record in which the app name 603 is “app A” from the app table 601. The retouching information table name 604 of the acquired record is “app A item table.”

The CPU 201 refers to the retouching information A item table 610 of FIG. 6B in which the columns of the app A item table are defined. The CPU 201 compares the items displayed in the retouching information 704 with the items registered in the retouching information A item table 610, and adds an item “highlight” not included in the retouching information 704 to the camera setting value 703 to display that item.

When it is detected that an app addition button 707 is pressed, the CPU 201 displays the items of the retouching information of an app which can be added with reference to the app table 601. In the app table 601, records of apps A and B are stored. In FIG. 7, since the items of the retouching information of the app A are displayed in the retouching information 704, the CPU 201 adds the items of the retouching information of the app B to the retouching information 704 for display. The CPU 201 can acquire the items of the retouching information of the app B from the retouching information B item table 620 illustrated in FIG. 6C.

When it is detected that a posting button 708 is pressed, the CPU 201 registers the image 702, the camera setting values 703, the retouching information 704 input by the user as a photo-recipe on the recording medium 204.

Here, various tables in which information regarding the photo-recipe are stored will be described with reference to FIGS. 8 to 11. The photo-recipe is registered in a camera setting value table, a retouching information table, an image camera-related table 1001, and an image retouching information-related table 1101. In an example to be described below, the camera setting value table is generated for each model of the camera. The retouching information table is generated for each app.

FIG. 8 is a diagram illustrating a camera setting value table. The camera setting value table is a table in which the camera setting values are stored and is generated for each model name of the camera. In FIG. 8, a camera setting value table 801 of the camera A is exemplified. The camera setting value table 801 includes columns of a camera setting value ID, a lens name, white balance, a focal distance, ISO, a photometric mode, exposure correction, a shutter speed, a diaphragm, and an imaging mode.

The camera setting value ID is an ID for identifying the camera setting values registered in other columns. The columns excluding the camera setting value ID are columns for registering values input to the camera setting values 703 on the photo-recipe registration screen 701 of FIG. 7. The camera setting value table is not limited to a case in which the table is generated for each model name of the camera and camera setting values of a plurality of cameras may be managed with one table.

FIGS. 9A and 9B are diagrams illustrating a retouching information table. The retouching information table is a table for storing the retouching information and is generated for each kind of app. In FIG. 9A, the retouching information A table 901 of the app A is exemplified. In FIG. 9B, the retouching information B table 911 of the app B is exemplified.

The retouching information table 901 of FIG. 9A includes the columns of the retouching information ID, the contrast, the grain, and the highlight. The retouching information ID is an ID for identifying retouching information registered in the other columns. The columns excluding the retouching information ID are columns for registering values input to the retouching information 704 on the photo-recipe registration screen 701 of FIG. 7.

Similarly, the retouching information table 911 of FIG. 9B includes columns of the retouching information ID, the contrast, and the grain. The retouching information table is not limited to a case in which the table is generated for each kind of app and retouching information of a plurality of apps may be managed with one table.

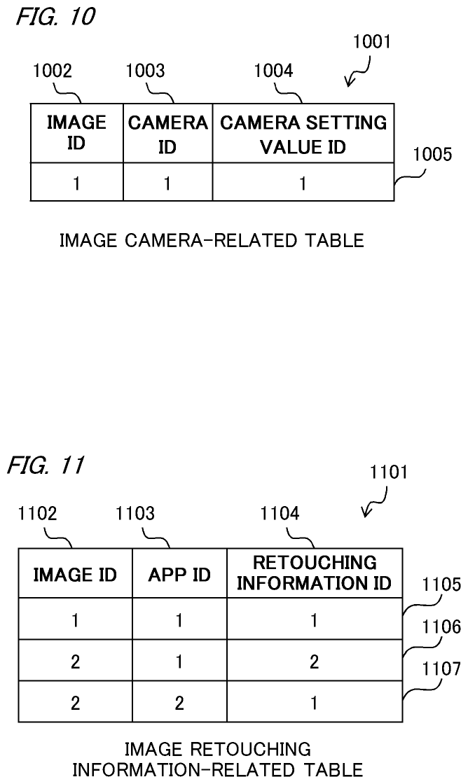

FIG. 10 is a diagram illustrating an image camera-related table 1001. The image camera-related table 1001 is a table in which a relation among an image, a camera, and a camera setting value is defined. The image camera-related table 1001 includes columns of an image ID 1002, a camera ID 1003, and a camera setting value ID 1004.

The image ID 1002 is an ID of an image registered on the photo-recipe registration screen 701. The camera ID 1003 is an ID of a camera capturing a registered image. The camera setting value ID 1004 is an ID of a camera setting value of the registered image. The CPU 201 can identify a record stored in the camera setting value table 801 with the camera setting value ID 1004 and acquire the corresponding camera setting value.

FIG. 11 is a diagram illustrating an image retouching information-related table 1101. The image retouching information-related table 1101 is a table in which a relation among an image, an app, and retouching information is defined. The image retouching information-related table 1101 includes columns of an image ID 1102, an app ID 1103, and retouching information ID 1104.

The image ID 1102 is an ID of an image to be registered on the photo-recipe registration screen 701. The app ID 1103 is an ID of an app for retouching (editing) the image to be registered. The retouching information ID 1104 is an ID of retouching information of the image to be registered. The CPU 201 can acquire the retouching information table corresponding to the app ID 1103 with reference to the app table 601. The CPU 201 can identify a record corresponding to the retouching information ID 1104 on the acquired retouching information table and acquire the retouching information.

A specific example in which the content of the image 702, the camera setting values 703, the retouching information 704 is registered in the camera setting value table 801, the retouching information table 901, the image camera-related table 1001, and the image retouching information-related table 1101 will be described with reference to FIG. 7.

The camera A is input in the row of the camera name of the camera setting value 703. With reference to the camera table 401, the camera ID of the camera A used to capture the image 702 is 1 and the camera setting value table name is the camera A setting value table 801. The CPU 201 sets 1 as the camera setting value ID and registers the content of the camera setting value 703 except for the camera name in the record 802 of the camera A setting value table 801.

The CPU 201 inserts the image 702 and a record 1005 associating the camera input with the camera setting value 703 with the camera setting value into the image camera-related table 1001. The image ID 1002 is set to 1 which is an image ID of the image 702. The camera ID 1003 is set to 1 which is the camera ID of the camera A. The camera setting value ID 1004 is set to 1 which is the camera setting value ID of the record 802 registered in the camera setting value table 801.

The app A is input in the row of the app name of the retouching information 704. With reference to the app table 601, an app ID of the app A used to edit the image 702 is 1 and the retouching information table name is the retouching information A table 901. The CPU 201 sets 1 as the retouching information ID and registers the content of the retouching information 704 except for the app name in the record 902 of the retouching information A table 901.

The CPU 201 inserts the image 702 and a record 1105 associating the app input with the retouching information 704 with the retouching information into the image retouching information-related table 1101. The image ID 1102 is set to 1 which is an image ID of the image 702. The app ID 1103 is set to 1 which is the app ID of the app A. The retouching information ID 1104 is set to 1 which is the retouching information ID of the record 902 registered in the retouching information table 901.

The retouching information 704 in FIG. 7 indicates retouching information when an image is edited with one app, but may include retouching information regarding a plurality of apps. For example, when an image with an image ID2 is edited with two kinds of apps, the retouching information corresponding to the apps is registered as a record 903 of the retouching information A table 901 and a record 912 of the retouching information B table 911. Information associating the image with the retouching information is registered as records 1106 and 1107 in the image retouching information-related table 1101.

In the embodiment, the photo-recipe is generated by the user and may be a camera setting value and retouching information acquired from an app of an external device. The camera setting value and the retouching information included in the photo-recipe are not limited to a case in which the camera setting value and the retouching information are managed with the table structures illustrated in FIGS. 8 to 11. The camera setting value and the retouching information may be registered and managed with any table structure as long as a relation between the image and the camera setting value and a relation between the image and the retouching information can be managed.

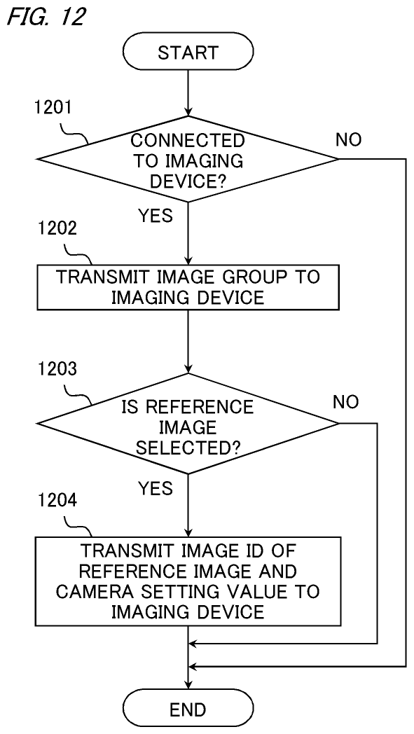

Acquisition Processing for Camera Setting Value: Acquisition processing for the camera setting value (the imaging setting information) will be described with reference to FIG. 12. The acquisition processing for the camera setting value is processing in which the editing device 102 transmits the image group to the imaging device 103, acquires the camera setting value associated with the reference image selected by the user, and transmits the camera setting value to the imaging device 103. When connection from the imaging device 103 is detected, the editing device 102 activates a photo-recipe application program to start the acquisition processing for the camera setting value.

In S1201, the CPU 201 of the editing device 102 determines whether the editing device 102 is connected to the imaging device 103. When the editing device 102 is connected to the imaging device 103 (YES in S1201), the processing proceeds to S1202. When the editing device 102 is not connected to the imaging device 103 (NO in S1201), the acquisition processing for the camera setting value ends.

In S1202, the CPU 201 transmits the image group registered in the recording medium 204 to the imaging device 103. The CPU 221 of the imaging device 103 displays the image group received from the editing device 102 on the display 231. The user selects an image (reference image) desired to be imitated from the image group displayed on the display 231.

In S1203, the CPU 201 detects whether the reference image is selected with the imaging device 103. When the reference image is selected (YES in S1203), the processing proceeds to S1204. When the reference image is not selected (NO in S1203), the acquisition processing for the camera setting value ends.

In S1204, the CPU 201 acquires the image ID of the selected reference image and the corresponding camera setting value with reference to the image camera-related table 1001. The CPU 201 transmits the acquired image ID and camera setting value to the imaging device 103.

For example, when the image ID is 1, the camera ID is 1 and the camera setting value ID is 1 with reference to the record 1005 of the image camera-related table 1001. With reference to the camera table 401, the camera setting value table name 404 of which the camera ID 402 is 1 is the camera A setting value table 801. The CPU 201 can identify the record 802 in which the camera setting value ID is 1 from the camera A setting value table 801 and acquire the camera setting value for the image of which the image ID is 1.

After the acquisition processing for the camera setting value ends, the editing device 102 enters a waiting state. When connection for requesting transmission of the image group from the imaging device 103 is detected, the editing device 102 repeats the processing illustrated in FIG. 12.

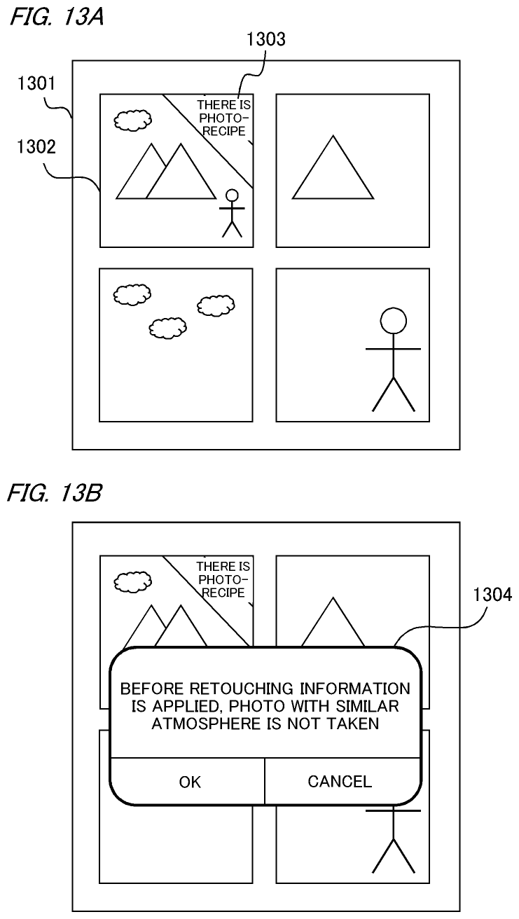

Imaging by Imaging Device: Imaging by the imaging device 103 will be described with reference to FIGS. 13A and 13B. The imaging device 103 performs imaging using the camera setting values of the reference image selected by the user among the images received from the editing device 102. FIGS. 13A and 13B are diagrams illustrating screens on which an image group is displayed on the imaging device 103.

In FIG. 13A, a screen on which an image group 1301 received from the editing device 102 by the imaging device 103 is displayed is exemplified. The CPU 221 of the imaging device 103 is connected to the editing device 102 and receives the image group 1301. The CPU 221 displays the image group 1301 on the display 231.

The CPU 221 may display a label 1303 indicating that there is a photo-recipe in the image 1302 in which there is the photo-recipe. The CPU 221 receives a selection of an image desired to be imitated from the user. The user can perform, for example, a touching manipulation to select the image desired to be imitated as the reference image.

FIG. 13B is a diagram illustrating an example of an alert displayed when the user selects the reference image. When the user selects the image 1302, the CPU 221 displays a pop-up 1304 to alert a possibility of an intended photo not being taken before the retouching information is applied. That is, before the captured image is transmitted to the editing device 102 and the retouching processing is applied in accordance with the retouching information, there is a possibility of the captured image having no atmosphere similar to the reference image selected by the user.

A timing of the alert to the user is not limited to the time of selection of the reference image, and the alert may be displayed when the imaging device 103 is connected to the editing device 102 to transmit the captured image. A method for the alert is not limited to the display of the pop-up, and a screen on which the image group is displayed may be switched to a screen on which the alert is displayed or the alert may be notified of by a sound.

In the example of FIG. 13A, the image group 1301 displays the image received from the editing device 102 irrespective of presence or absence of the retouching information, but the present invention is not limited thereto. The image group 1301 may be narrowed down to images that have a photo-recipe, images that have camera setting values and no retouching information, images captured with the same camera as the imaging device 103, or the like.

The image group 1301 may be images that are narrowed sown in various conditions, such as images edited with the retouching information that satisfies a predetermined condition that the contrast is +2 or more or images captured with the camera setting values that satisfy a predetermined condition that a usage lens is “lens A.” The image group 1301 may be narrowed down in the editing device 102 or may be narrowed down in the imaging device 103.

The CPU 221 of the imaging device 103 notifies the editing device 102 of the selected reference image when it is detected that an OK button of the pop-up 1304 is pressed. The CPU 221 receives the image ID and the camera setting value of the selected reference image from the editing device 102 and sets the received camera setting values in the imaging unit 224 of the imaging device 103.

When the camera of the imaging device 103 is different from a camera corresponding to the camera setting values received from the editing device 102, the CPU 221 can apply the camera setting values based on a correspondence relation between the items of preset camera setting values.

The CPU 221 may notify the user of the camera setting values which have not automatically been applied to the imaging unit 224. For example, when a lens used in the imaging device 103 is different from a lens (a lens used to capture the reference image) with the received camera setting values, the CPU 221 may display a notification “The reference image is captured using a lens A.” The user can exchange the lens or adjust the setting of the camera based on the camera setting values which have not automatically been applied.

The CPU 221 of the imaging device 103 assigns the image ID of the reference image to a captured image. For example, when an image selected from the image group 1301 is the image 1302 (the image 702 illustrated in FIG. 7), the imaging device 103 receives the image ID of 1 and the camera setting values registered in the record 802 of the camera A setting value table 801. The CPU 221 transmits the captured image to which 1 which is the image ID of the reference image is assigned, to the editing device 102.

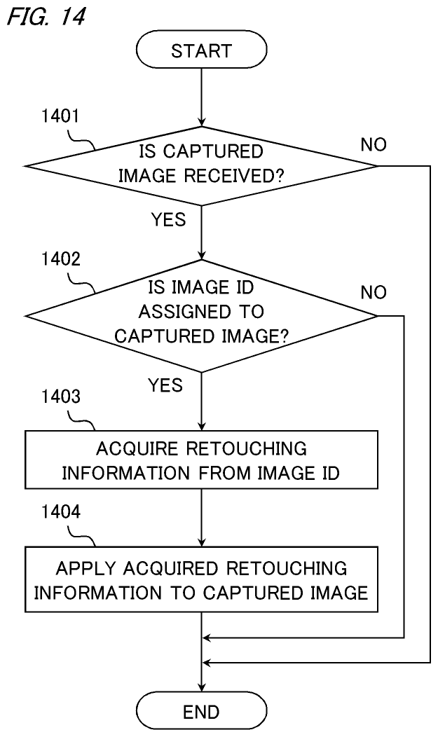

Application Processing for Retouching Information: Application processing for the retouching information will be described with reference to FIG. 14. The application processing for the retouching information is processing in which the editing device 102 applies the retouching processing in accordance with the retouching information to the captured image received from the imaging device 103.

In S1401, the CPU 201 of the editing device 102 determines whether the captured image is received from the imaging device 103. When the captured image is received (YES in S1401), the processing proceeds to S1402. When the captured image is not received (NO in S1401), the application processing for the retouching information ends.

In S1402, the CPU 201 determines whether the image ID of the reference image desired to be imitated by the user is assigned to the captured image received from the imaging device 103. When the image ID is assigned (YES in S1402), the processing proceeds to S1403. When the image ID is not assigned (NO in S1402), the application processing for the retouching information ends.

In S1403, the CPU 201 acquires the retouching information corresponding to the image ID of the selected reference image with reference to the image retouching information-related table 1101 and the retouching information table for each app.

For example, when the image ID of the reference image assigned to the captured image is 1, the corresponding app ID is 1 and the retouching information ID is 1 with reference to the record 1105 of the image retouching information-related table 1101. With reference to the app table 601, the retouching information table name corresponding to the app of which the app ID is 1 is the retouching information A table 901. The CPU 201 can acquire the retouching information corresponding to the reference image of which the image ID is 1 from the record 902 in which the retouching information ID is 1 in the retouching information A table 901.

In S1404, the CPU 201 applies the retouching processing to the captured image received from the imaging device 103 based on the retouching information acquired in S1403. The editing device 102 may have a function of displaying images before and after application of the retouching information comparably.

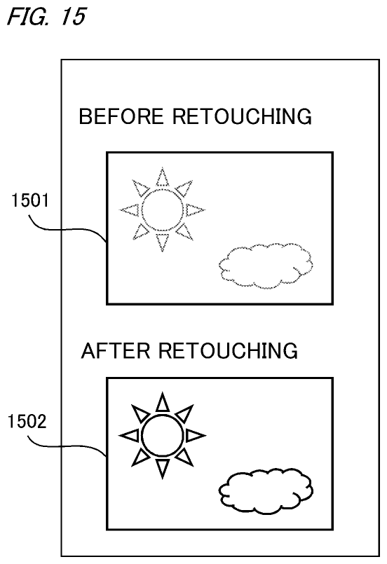

Here, a screen on which the images before and after application of the retouching information are displayed will be described with reference to FIG. 15. FIG. 15 is a diagram illustrating a screen on which captured images before and after application of the retouching information are displayed. The CPU 201 displays a captured image 1501 before application of the retouching information and a captured image 1502 after application of the retouching information on the display 211 of the editing device 102. The user can easily compare the captured images before and after application of the retouching information.

A method of presenting the captured images before and after application of the retouching information to the user is not limited to the example of FIG. 15. The CPU 201 may display the image after application of the retouching information larger than the image before application of the retouching information or may switch and display the images before and after application of the retouching information in response to a user manipulation.

The editing device 102 may have a function of transmitting a captured image to which the retouching information is applied to an SNS or the like. The user can automatically transfer the captured image edited in accordance with the retouching information to an SNS by registering the SNS of a predetermined transmission destination in advance.

The editing device 102 may have a function of retouching (editing) the captured image to which the retouching information is applied again. For example, when the user gives an instruction (performs a manipulation) to start editing the captured image to which the retouching information is applied, an app for editing the image is activated. The activated app may be an app corresponding to the applied retouching information or may be an app designed in advance by the user. When the app to be active is not installed, the editing device 102 may automatically install the app or urge the user to install the app.

According to the above-described first embodiment, the user can set the camera setting values of the imaging device 103 similarly to those of the reference image by selecting the reference image that has the photo-recipe and can perform imaging. Since the captured image is edited based on the retouching information of the reference image by the editing device 102, the user can generate the image having an atmosphere similar to that of the reference image.

### Second Embodiment

Hereinafter, a preferred second exemplary embodiments of the present invention will be described in detail with reference to the drawings. Here, constituent elements described in the embodiments are merely exemplary and do not limit the scope of the present invention.

The first embodiment is an embodiment in which the editing device 102 applies the retouching information to the captured image in accordance with the retouching information. On the other hand, the second embodiment is an embodiment in which the imaging device 103 applies the retouching process to a captured image in accordance with the retouching information of the reference image.

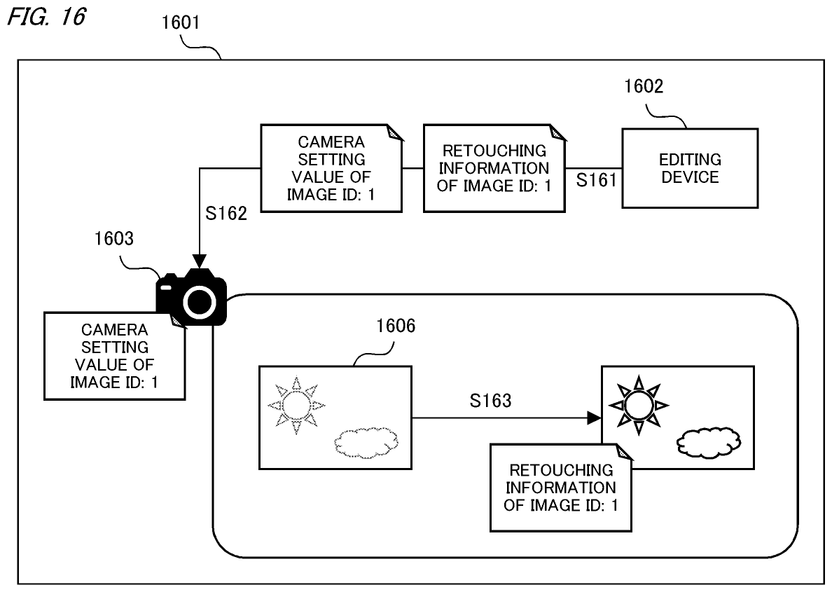

An overview of an image processing system according to the embodiment will be described with reference to FIG. 16. An image processing system 1601 includes an editing device 1602 and an imaging device 1603. Since the configurations of the editing device 1602 and the imaging device 1603 are the same as those of the editing device 102 and the imaging device 103 according to the first embodiment, detailed description thereof will be omitted.

The editing device 1602 transmits an image group to the imaging device 1603 and detects whether the reference image is selected from the transmitted image group. FIG. 16 illustrates an example in which an image of which an image ID is 1 is selected as a reference image. When it is detected that the reference image of which the image ID is 1 is selected, the editing device 1602 transmits camera setting values and retouching information associated with the reference image to the imaging device 1603 (S161).

The CPU 221 of the imaging device 1603 receives the camera setting values and the retouching information with respect to the reference image of which the image ID is 1 from the editing device 1602 (S162). The imaging device 1603 sets the received camera setting values in the imaging unit 224 of the imaging device 1603. The CPU 221 causes the imaging unit 224 to capture an image and applies the retouching information of the reference image of which the image ID is 1 to a captured image 1606 (S163).

The imaging device 1603 may have a function of displaying captured images before and after application of the retouching information. When a display region of the display 231 in the imaging device 1603 is restricted, the captured images before and after application of the retouching information may not be arranged and display as in FIG. 15, but may be the image before application and the image after application may be switched and displayed.

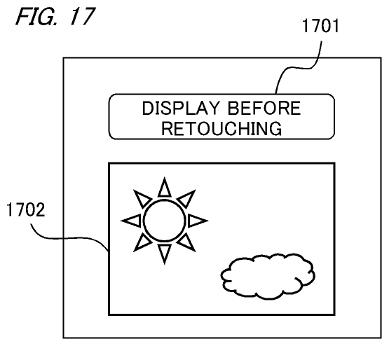

FIG. 17 is a diagram illustrating an example in which captured images before and after application of the retouching information are displayed. In FIG. 17, a captured image 1702 after application of the retouching information is displayed. When it is detected that a button 1701 with a label “display before retouching” is pressed, the CPU 221 of the imaging device 1603 switches the image 1702 after application of the retouching information to the image before application of the retouching information.

As in the first embodiment, the imaging device 1603 may have a function of transmitting a captured image to which the retouching information is applied to an SNS or the like. The imaging device 1603 may have a function of retouching the captured image to which the retouching information is applied again. When app for retouching the captured image is not installed, the imaging device 1603 may automatically install the app or urge the user to install the app.

According to the above-described second embodiment, the user can set the camera setting values of the imaging device 103 similarly to those of the reference image by selecting the reference image that has the photo-recipe and can perform imaging. Since the captured image is edited based on the retouching information of the reference image by the imaging device 103, the user can generate the image having an atmosphere similar to that of the reference image without transmitting the captured image to the editing device 102.

The preferred embodiments of the present invention have been described above in detail, but the present invention is not limited to the specific embodiments. The present invention includes various forms within the scope of the present invention without departing from the gist of the present invention. The above-described embodiments may be partially combined.

The present invention also includes a case in which a program of software for implementing the functions of the above-described embodiments is supplied directly or through wired or wireless communication from a recording medium to a system and a device that includes a computer capable of executing the program so that the program is executed.

Accordingly, since the functions according to the embodiments of the present invention are implemented, program codes supplied and installed in the computer also implement the present invention. That is, the present invention also includes a computer program for implements the functions of the embodiments. When there is a function of the program, a program executed by an object code or an interpreter and a form of a program such as script data supplied to an OS do not matter.

A recording medium for supplying the program is, for example, a magnetic recording medium such as a hard disk or a magnetic tape, an optical/photomagnetic recording medium, or a nonvolatile semiconductor memory. A method of supplying the program may be, for example, a method of registering a program that implements the present invention in a server on a computer network and causing a client computer connected to the server to download and execute the program.

According to the present disclosure, it is possible to reduce time and effort for generating an image with an atmosphere similar to that of an image selected by a user.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-034260, filed on Mar. 4, 2021, which is hereby incorporated by reference herein in its entirety.

What is claimed is:

1. An imaging device comprising at least one memory and at least one processor which function as:
an acquisition unit configured to acquire imaging setting information in capturing of a reference image and image editing information applied to the reference image;
an imaging unit configured to control of imaging using the imaging setting information acquired by the acquisition unit; and
an editing unit configured to edit a captured image captured by the imaging unit based on the image editing information acquired by the acquisition unit.

2. The imaging device according to claim 1,
wherein the acquisition unit acquires the imaging setting information and the image editing information, and
wherein the editing unit edits the captured image based on the image editing information acquired by the acquisition unit.

3. The imaging device according to claim 1,
wherein the at least one memory and the at least one processor further function as:
a display control unit configured to display a plurality of images associated with at least one of the imaging setting information or the image editing information, and
wherein the reference image is an image selected by a user from the plurality of images.

4. The imaging device according to claim 3,
wherein the display control unit narrows down and displays the plurality of images based on a condition designated by the user.

5. The imaging device according to claim 3,
wherein, in a case where the user selects an image associated with the image editing information as the reference image, the display control unit notifies the user that the captured image before application of the image editing information does not have an atmosphere similar to an atmosphere of the reference image.

6. The imaging device according to claim 1,
wherein the at least one memory and the at least one processor further function as:
a transfer unit configured to transfer the captured image edited by the editing unit to a predetermined transmission destination.

7. The imaging device according to claim 1,
wherein the editing unit comparably displays the captured image and the captured image to which the image editing information is applied.

8. The imaging device according to claim 1,
wherein the editing unit further edits the captured image to which the image editing information is applied in response to a manipulation from a user.

9. An image processing device comprising at least one memory and at least one processor which function as:
a registration unit configured to register imaging setting information in capturing of a reference image and image editing information applied to the reference image in a storage unit in association with the reference image;
a transmission unit configured to transmit the imaging setting information corresponding to the reference image to an imaging device;
a reception unit configured to receive a captured image captured using the imaging setting information from the imaging device; and
an editing unit configured to edit the captured image based on the image editing information associated with the reference image.

10. The image processing device according to claim 9,
wherein the registration unit registers the imaging setting information and the image editing information in association with identification information of the reference image, and
wherein the editing unit acquires the image editing information associated with the identification information assigned to data of the captured image from the storage unit and edits the captured image based on the acquired image editing information.

11. The image processing device according to claim 9,
wherein the registration unit registers information of an imaging device, to which the imaging setting information is applied, in association with the imaging setting information.

12. The image processing device according to claim 9,
wherein the registration unit registers information of an application, which is used to apply the image editing information to the captured image, in association with the image editing information.

13. The image processing device according to claim 12,
wherein, in a case where the image editing information is applied to the captured image and the application is not installed, the editing unit automatically installs the application or prompts a user to install the application.

14. The image processing device according to claim 9,
wherein the at least one memory and the at least one processor further function as:
a transfer unit configured to transfer the captured image edited by the editing unit to a predetermined transmission destination.

15. The image processing device according to claim 9,
wherein the editing unit comparably displays the captured image and the captured image to which the image editing information is applied.

16. The image processing device according to claim 9,
wherein the editing unit further edits the captured image to which the image editing information is applied in response to a manipulation from a user.

17. A method of controlling an imaging device, the method comprising:
an acquiring step of acquiring imaging setting information in capturing of a reference image and image editing information applied to the reference image;
an imaging step of performing imaging using the imaging setting information acquired in the acquiring step; and
an editing step of editing a captured image captured in the imaging step based on the image editing information acquired in the acquiring step.

18. A non-transitory computer-readable storage medium that stores a program causing a computer to execute:
an acquiring step of acquiring imaging setting information in capturing of a reference image and image editing information applied to the reference image;
an imaging step of performing imaging using the imaging setting information acquired in the acquiring step; and
an editing step of editing a captured image captured in the imaging step based on the image editing information acquired in the acquiring step.
